(19) United States
(12) Patent Application Publication
(10) Pub. No.: US 2002/0060747 A1
(43) Pub. Date: May 23, 2002

(54) Digital broadcasting receiving device with advertising information outputting function

(75) Inventor: Takaya Nonomura, Osaka (JP)

Correspondence Address: RADER FISHMAN & GRAUER, PLLC, Suite 501, 1233 20th Street, N.W., Washington, DC, 20036, US

(73) Assignee: SANYO ELECTRIC CO., LTD.

(21) Appl. No.: 09/988,336

(22) Filed: Nov. 19, 2001

(30) Foreign Application Priority Data
Nov. 21, 2000 (JP) 354029/2000

(51) Int. Cl. H04N 7/025

(52) U.S. Cl. 348/465; 725/36

(57) ABSTRACT

Advertising information and advertising area information are carried on a digital broadcasting wave. A CPU acquires the current position on the basis of demodulation data outputted from a GPS receiving circuit and a beacon receiving circuit, takes out advertising information having advertising area information existing within a predetermined range, centered around the current position, and stores the advertising information in a CM data memory. The CPU reads out, when it detects that a program which is being currently received is switched into a commercial (CM) on the basis of a mode signal outputted from an AV decoder, the advertising information from the CM data memory, and outputs the advertising information by audio/video in place of the commercial.

### BACKGROUND OF THE INVENTION

### Field of the Invention

The present invention relates to a digital broadcasting receiving device with an advertising information outputting function capable of receiving digital broadcasting and presenting advertising information to a user.

A digital broadcasting receiving device for receiving digital broadcasting using a satellite or a ground wave selects an arbitrary broadcasting wave out of a plurality of broadcasting waves which are received through a dedicated antenna or a ground wave antenna by a tuner, selects an arbitrary channel out of a plurality of channels included in the selected broadcasting wave by demultiplexing processing, takes out a digital signal on the selected channel, and decodes the digital signal, to output a video/audio signal.

Meanwhile, a commercial (CM) in conventional television broadcasting is in a mass communication manner in which the same commercial is presented to all viewers. Partially in a local broadcasting station, a commercial in the local edition is only inserted. That is, it is not realized that a local commercial closely related to a living area of the viewer is continuously presented. Further, even if a time service or the like is unexpectedly furnished in a shop existing in the vicinity of a residential area of the viewer, it is not realized that the viewer is timely informed that the time service is furnished through television broadcasting.

The present invention has been made in view of the above-mentioned circumstances and has for its object to provide a digital broadcasting receiving device with an advertising information outputting function capable of presenting, in a place where a viewer is currently positioned, local commercials corresponding to the place.

### SUMMARY OF THE INVENTION

In order to solve the above-mentioned problem, a digital broadcasting receiving device with an advertising information outputting function according to the present invention is characterized by comprising a receiver for receiving a digital broadcasting wave; video/audio output means for outputting at least one of video and audio; means for taking out advertising information and advertising area information which are carried on the digital broadcasting wave; means for outputting information related to the current position; selection means for selecting the advertising information by the contrast between the information related to the current position and the advertising area information; and a controller for feeding the selected advertising information to the video/audio output means at predetermined timing.

In the above-mentioned configuration, the receiving device is fixedly installed in each home or the like, and the information related to the current position is inputted to the device by a user, for example. On the side of a broadcasting enterpriser, transmission is made with the advertising information and the advertising area information corresponding thereto carried on the digital broadcasting wave. In an advertisement for a shop which exists in New York, for example, the advertisement is transmitted with advertising area information representing “New York” added thereto. The device selects the advertising information by the contrast between the information related to the current position and the advertising area information, and outputs the selected advertising information by video/audio. In a place where a viewer is currently positioned, therefore, local commercials corresponding to the place are presented.

A digital broadcasting receiving device with an advertising information outputting function according to the present invention is characterized by comprising a first receiver for receiving a digital broadcasting wave; video/audio output means for outputting at least one of video and audio; means for taking out advertising information and advertising area information which are carried on the digital broadcasting wave; a second receiver for receiving a transmission wave on which information required to specify the current position is carried; means for outputting information related to the current position on the basis of the information carried on the transmission wave; selection means for selecting the advertising information by the contrast between the information related to the current position and the advertising area information; and a controller for feeding the selected advertising information to the video/audio output means at predetermined timing.

In the above-mentioned configuration, the information related to the current position is acquired on the basis of a transmission wave from satellites in a GPS (Global Positioning System) or a beacon transmitter provided in a street corner, for example. On the side of a broadcasting enterpriser, transmission is made with the advertising information and the advertising area information corresponding thereto carried on the digital broadcasting wave. In an advertisement for a shop which exists in ◯◯ town, for example, the advertisement is transmitted with advertising area information representing “◯◯ town” added thereto. The receiving device selects the advertising information by the contrast between the advertising area information and the information related to the current position which is acquired by the second receiver, and outputs the selected advertising information by video/audio. Even in a case where the receiving device is moved with the device carried in a vehicle such as a bus, a family car, or a railroad car, or a case where the receiving device, together with a user, is moved as a portable device, therefore, local commercials corresponding to a place to which the device is moved are presented in the place.

The device may comprise a memory storing the advertising information and the advertising area information which are taken out of the digital broadcasting wave, and the selection means may be constructed such that the advertising information stored in the memory can be selected by the contrast between the information related to the current position and the advertising area information. This makes it possible to previously acquire and store advertising information collectively broadcast at midnight, for example, and output, even if no advertising information is broadcast in the daytime, the stored advertising information by video/audio.

A digital broadcasting receiving device with an advertising information outputting function according to the present invention is characterized by comprising a first receiver for receiving a digital broadcasting wave; video/audio output means for outputting at least one of video and audio; a memory storing advertising information and advertising area information; a second receiver for receiving a transmission wave on which information required to specify the current position is carried; means for outputting information related to the current position on the basis of the information carried on the transmission wave; selection means for selecting the advertising information by the contrast between the information related to the current position and the advertising area information; and a controller for feeding the selected advertising information to the video/audio output means at predetermined timing.

In the above-mentioned configuration, the information related to the current position is acquired on the basis of a transmission wave from satellites in a GPS or a beacon transmitter provided in a street corner, for example. The advertising information and the advertising area information corresponding thereto are stored in the memory. In an advertisement for a shop which exists in ◯◯ town, for example, the advertisement is stored with a correspondence between the advertisement and advertising area information representing “◯◯ town” established therebetween. The receiving device selects the advertising information by the contrast between the advertising area information and the information related to the current position which is acquired by the second receiver, and outputs the selected advertising information by video/audio. In a case where the receiving device is moved with the device carried in a vehicle such as a bus, a family car, or a railroad car, or a case where the receiving device, together with a user, is moved as a portable device, therefore, local commercials corresponding to a place to which the device is moved are presented in the place.

The device may comprise judgment means for judging whether or not video and audio which are being currently outputted are a commercial (CM) appended to a program, and the controller may be so constructed as to feed to the video/audio output means the advertising information selected when the judgment means judges that they are the commercial (CM). This makes it possible to provide the advertising information in place of the commercial appended to the program without affecting the program itself.

The controller may be so constructed as to feed the advertising information selected in the selection means to the video/audio output means simultaneously with the selection. This makes it possible to avoid such situations that the receiving device separates, if it waits for certain timing, from an advertising area because it is moving, and misses the chance to present the advertising information and to reliably present the advertising information to the viewer.

When a signal representing the timing of outputting the advertising information is received, the controller may feed the advertising information selected in the selection means to the video/audio output means. Examples of the signal representing the output timing include an output instruction signal carried on the digital broadcasting wave. Further, when a beacon is transmitted only when required, a beacon signal also becomes a signal representing output timing.

The device may comprise message output means for outputting a message saying that the advertising information exists, and the controller may be so constructed as to feed the advertising information selected when an advertising output operation is performed by a user to the video/audio output means. Consequently, the advertising information is outputted by video/audio on the basis of the intension of the user.

The foregoing and other objects, features, aspects and advantages of the present invention will become more apparent from the following detailed description of the present invention when taken in conjunction with the appended to drawings.

### BRIEF DESCRIPTION OF THE DRAWINGS

FIG. 1 is a block diagram showing a digital broadcasting receiving device with an advertising information outputting function according to an embodiment of the present invention;

FIG. 2 is a block diagram showing another example of a digital broadcasting receiving device with an advertising information outputting function; and

FIG. 3 is a block diagram showing still another example of a digital broadcasting receiving device with an advertising information outputting function.

### DESCRIPTION OF THE PREFERRED EMBODIMENTS

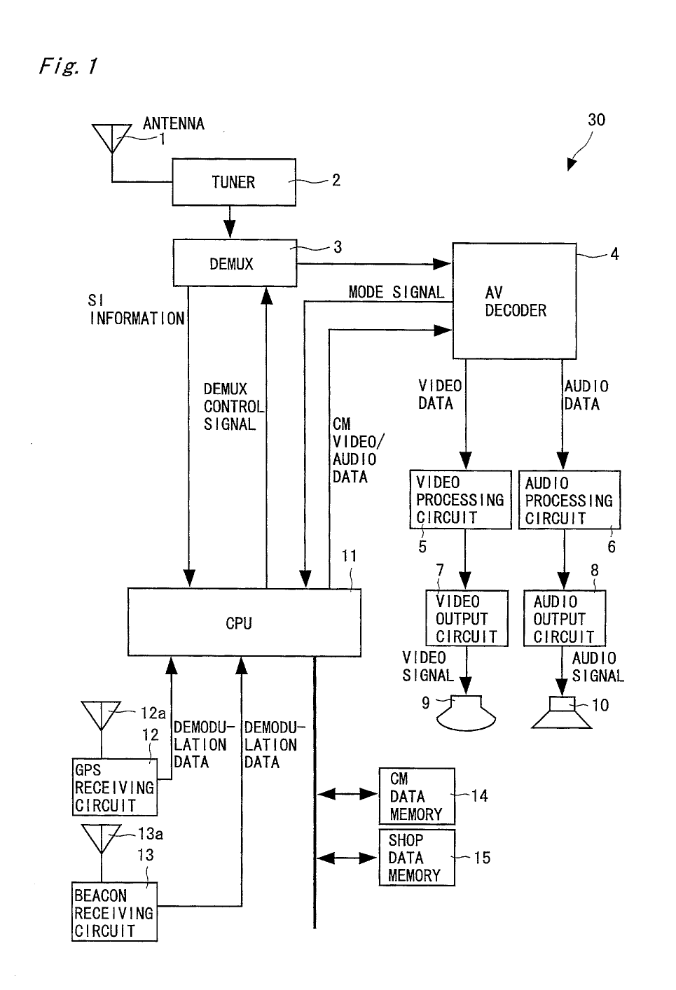

An embodiment of the present invention will be described on the basis of FIG. 1. Here, a case where a user views ground wave digital broadcasting is illustrated. FIG. 1 is a block diagram showing a digital broadcasting receiving device with an advertising information outputting function 30 in the present embodiment for receiving the ground wave digital broadcasting.

In FIG. 1, an antenna 1 receives a digital broadcasting signal transmitted from a ground wave broadcasting station.

A tuner 2 takes out a signal having a particular frequency out of high-frequency digital modulation signals including video/audio data. Further, the tuner 2 comprises an inverse interleave circuit, an error correcting circuit, and so forth, thereby demodulating the selected digital modulation signal to output a transport stream.

A demultiplexer (DEMUX) 3 separates the transport stream received from the tuner 2 into a video transport packet and an audio transport packet based on MPEG2 (Moving Picture Experts Group2) and PSI (Program Specific Information).

The demultiplexer 3 feeds the video transport packet and the audio transport packet to an AV decoder 4, and feeds service information (SI) included in the PSI, for example, to a CPU 11.

As described in the foregoing, a plurality of channels are multiplexed on the transport stream. Processing for selecting any one of the channels can be performed by taking out data indicating which packet ID in the transport stream is used to multiplex the arbitrary channel from the PSI/SI.

Not only a main channel but also a subchannel is multiplexed on the digital broadcasting wave. When a DEMUX control signal is fed to the demultiplexer 3 from a CPU 11 so as to select the subchannel, a video transport packet and an audio transport packet in the subchannel are outputted.

Furthermore, data broadcasting for providing a still image, character information, and audio information is also multiplexed on the digital broadcasting wave. In program broadcasting, a commercial (CM) is inserted everywhere. However, advertising information other than the commercial can be incorporated into the subchannel or the data broadcasting. Of course, a channel that specializes in advertising information can be also provided.

Information indicating in which subchannel, for example, the advertising information exists, and advertising area information (e.g., information related to latitude and longitude) indicating in which area the advertising information should be broadcast are previously inserted into the SI. On the side of the transmission of the advertising information (on the side of a broadcasting enterpriser), even if a system capable of not only successively sending out advertising information previously requested but also coping with an unexpected advertising request is arranged, it is possible to timely carry, when a certain shop unexpectedly furnishes a time service or the like, advertising information for informing a viewer that the time service is furnished on the broadcasting wave.

The AV decoder 4 comprises a video decoder for decoding the video transport packet and an audio decoder for decoding the audio transport packet. The video decoder decodes an inputted variable length code to find a quantization factor and a motion vector, to carry out inverse DCT (Discrete Cosine Transformation) and motion compensation control based on the motion vector. The audio decoder decodes a coded signal which has been inputted, to generate audio data.

The video data generated by the decoding is outputted to a video processing circuit 5, and the audio data is outputted to an audio processing circuit 6. There is provided a data broadcasting decoder, which is not illustrated. The data broadcasting decoder decodes the data broadcasting packet, to generate still image video data and audio data, and other information.

The video processing circuit 5 subjects the video data to digital-to-analog (D/A) conversion, to convert the video data into a composite signal in an NTSC (National Television System Committee) format, for example. The audio signal processing circuit 6 subjects the audio data to D/A conversion, to generate an analog signal for a right (R) sound and an analog signal for a left (L) signal. A video output circuit 7 and an audio output circuit 8 are constructed by comprising a signal amplifier or the like. A monitor 9 displays video on the basis of a video signal fed from the video output circuit 7. A speaker 10 outputs audio on the basis of an audio signal fed from the audio output circuit 8.

A GPS (Global Positioning System) receiving circuit 12 is constructed by comprising an amplification circuit for amplifying a GPS signal received in an antenna 12a, a detection circuit, an analog-to-digital (A/D) converter, a data demodulation circuit, and so forth. The GPS receiving circuit 12 feeds demodulation data to the CPU 11.

A beacon receiving circuit 13 is constructed by comprising an amplification circuit for amplifying a beacon signal received in an antenna 13a, a detection circuit, a data demodulation circuit, and so forth. The beacon receiving circuit 13 feeds demodulation data to the CPU 11. A device for transmitting the beacon signal is installed in a building, a utility pole, and so forth near a road.

The CPU 11 calculates information related to the current position (for example, information related to latitude and longitude) on the basis of the demodulation data. An operation processing program for calculating the information related to the current position is stored in a memory (not shown). Further, the CPU 11 takes out the advertising area information included in the SI, and compares the advertising area information with the above-mentioned information related to the current position. When both the information are the information related to latitude and longitude, for example, it is judged whether or not the advertising area information (latitude and longitude) exists in a circular area in a predetermined range, centered around the current latitude and longitude. When the advertising area information (latitude and longitude) exists in the predetermined range, it is judged in which subchannel, for example, the advertising information corresponding to the advertising area information exists, to take out an advertising information packet in the subchannel and store the advertising information packet in a CM data memory 14.

The CPU 11 inputs a mode signal from the AV decoder 4. The mode signal is changed when a commercial is aired in broadcasting. The CPU 11 judges whether or not a program is switched into a commercial on the basis of the mode signal. When it is judged that the program is switched into the commercial, advertising information is read out of the CM data memory 14, and the advertising information is fed to the AV decoder 4 or a data broadcasting decoder (not shown), to perform both or one of video output and audio output of the advertising information.

When the above-mentioned digital broadcasting receiving device with an advertising information outputting function is moved with the device carried in a vehicle such as a bus, a family car, or a railroad car, the information related to the current position is gradually changed. Accordingly, in a place where a viewer is currently positioned, local advertising information corresponding to the place is presented.

It is also possible to perform processing for selecting advertising information which is being currently broadcast on the basis of the information related to the current position when a program which is being currently broadcast is switched into a commercial, to output the advertising information without comprising the CM data memory 14. That is, it is also possible to use a configuration (a mode) in which the advertising information selected by the contrast between the advertising area information and the information related to the current position is outputted by video/audio simultaneously with the selection. It is also possible to previously prepare several modes and cause a user to select one of the modes.

It is possible to take the time when a pilot signal (an output instruction signal) multiplexed on a digital broadcasting wave is received as timing of outputting advertising information besides taking the time when a program is switched into a commercial as timing of outputting advertising information. Alternatively, if a beacon is transmitted only when required (for example, transmitted when a time service is started), a beacon signal also becomes a signal representing output timing.

Although description was made of a case where the advertising information is carried on the subchannel, the present invention is not limited to the same. For example, the advertising information may be carried on sub-audio on a main channel or on data broadcasting multiplexed on a digital broadcasting wave as additional information to take out the advertising information. In the configuration comprising the CM data memory 14, it is possible to acquire and store advertising information collectively broadcast at midnight, for example, and output the stored advertising information by video/audio even if the advertising information is not broadcast in the daytime.

There may be provided a shop data memory 15 storing advertising information and advertising area information which are received in data transfer using a transmission wave other than the digital broadcasting wave or a wire in addition to the CM data memory 14 storing the advertising information carried on the digital broadcasting wave, to select and output the advertising information from the shop data memory 15. When the device is carried on a public vehicle such as a bus or a train, the shop data memory 15 may be provided. On the other hand, in a digital broadcasting receiving device with an advertising information outputting function which is carried on a family car, the shop data memory 15 is not required.

Although the configuration comprising both the GPS receiving circuit 12 and the beacon receiving circuit 13 is illustrated, a configuration comprising either one of them may be used. Although in the configuration shown in FIG. 1, advertising information in an undecoded state is stored in the CM data memory 14, and the advertising information in an undecoded state which has been read out of the CM data memory 14 is fed to the AV decoder 4 (or a data broadcasting decoder (not shown)), advertising information which has been decoded may be stored in the CM data memory 14, in which case the advertising information in a decoded state which has been read out of the CM data memory 14 can be directly fed to the video processing circuit 5 or the audio processing circuit 6.

Furthermore, in the configuration shown in FIG. 1, the advertising information as well as advertising area information corresponding thereto may be stored in the CM data memory 14. Even after the advertising information is acquired, the information related to the current position is gradually changed. When a program is switched into a commercial, the current position may, in some cases, separate from the predetermined range. When the advertising information is read out, the information related to the current position at the time of the reading and the advertising area information which has been previously stored are compared with each other. When the current position separates from the predetermined range, processing may be performed such that the advertising information is not outputted.

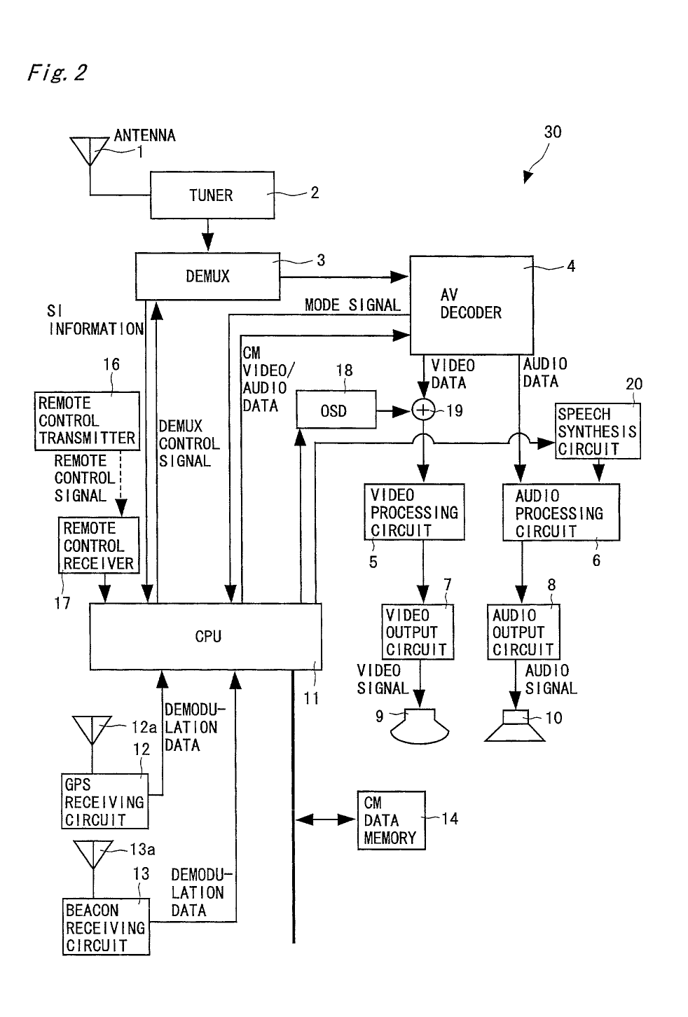

FIG. 2 is a block diagram showing another example of a digital broadcasting receiving device with an advertising information outputting function. A configuration shown in FIG. 2 comprises a remote control transmitter 16, a remote control receiver 17, an OSD (On Screen Display) circuit 18, an adder 19, and an speech synthesis circuit 20 in addition to the configuration shown in FIG. 1. The digital broadcasting receiving device with an advertising information outputting function shown in FIG. 2 may be carried on a family car. Further, it may be a device fused with a car navigation system.

The OSD circuit 18 outputs to the adder 19 bit map data based on character information whose output instruction is issued from the CPU 11. The adder 19 performs processing for incorporating the bit map data into a video signal. By the OSD circuit 12, it is possible to also perform the display of a operation guide on a screen and the display of a message (for example, character display saying “We can output advertising information”) for informing a user that advertising information exists besides realizing the display of an EPG (Electronic Program Guide) on the screen based on SI received by the CPU 11.

The speech synthesis circuit 20 has a memory storing speech data saying “We can output advertising information”, for example, with the speech data compressed, and reads out the speech data from the memory and expands the speech data in accordance with the instruction from the CPU 11, to fed the expanded speech digital signal to an audio processing circuit 6.

The remote control transmitter 16 is a transmitter for sending out a command to the digital broadcasting receiving device with an advertising information outputting function 30. When a key (not shown) provided in the remote control transmitter 16 is operated, signal light (a remote control signal) meaning a command corresponding to the key is sent out from a light emitter (not shown). The remote control receiver 17 receives the signal light, converts the signal light into an electric signal, and feeds the electric signal to the CPU 11.

Also in the configuration shown in FIG. 2, when advertising information corresponding to an area exists, as in the configuration shown in FIG. 1, the advertising information can be automatically outputted in place of a commercial appended to broadcasting. However, a message for informing the user that the advertising information exists is first outputted without automatically outputting the advertising information.

Specifically, when advertising information corresponding to an area exists in a digital broadcasting wave, the CPU 11 uses the OSD circuit 12, to perform processing for displaying a character message saying “We can output advertising information”, for example, with the character message overlapped with a presentation on a screen of a monitor 9 or using a part of the screen. In place thereof or in addition thereto, the speech synthesis circuit 20 is used, to perform processing for outputting from a speaker 10 a voice message saying “We can output advertising information”.

When the user operates the remote control transmitter 16 by seeing or hearing the message, to instruct the device 30 to output the advertising information, the CPU 11 stops outputting a program by video/audio, to output the advertising information read out of the CM data memory 14 by video/audio. Alternatively, the advertising information is displayed with the information overlapped with video of a program, or output of only audio of the program is stopped, to output the advertising information by audio.

The message to be displayed is not limited to the character message. For example, a predetermined mark may be intermittently displayed in a corner or the like of the screen. Further, light emission means such as an LED (Light Emitting Diode) may be flashed without using the OSD circuit 12, to take the flashing as a message for informing the user of the existence of the advertising information.

Although in the configurations shown in FIGS. 1 and 2, the advertising information is selected when the device 30 (a vehicle) merely enters an advertising area in a predetermined range, the advertising information may be selected in consideration of the direction of travel, for example, in addition to the current position of the vehicle.

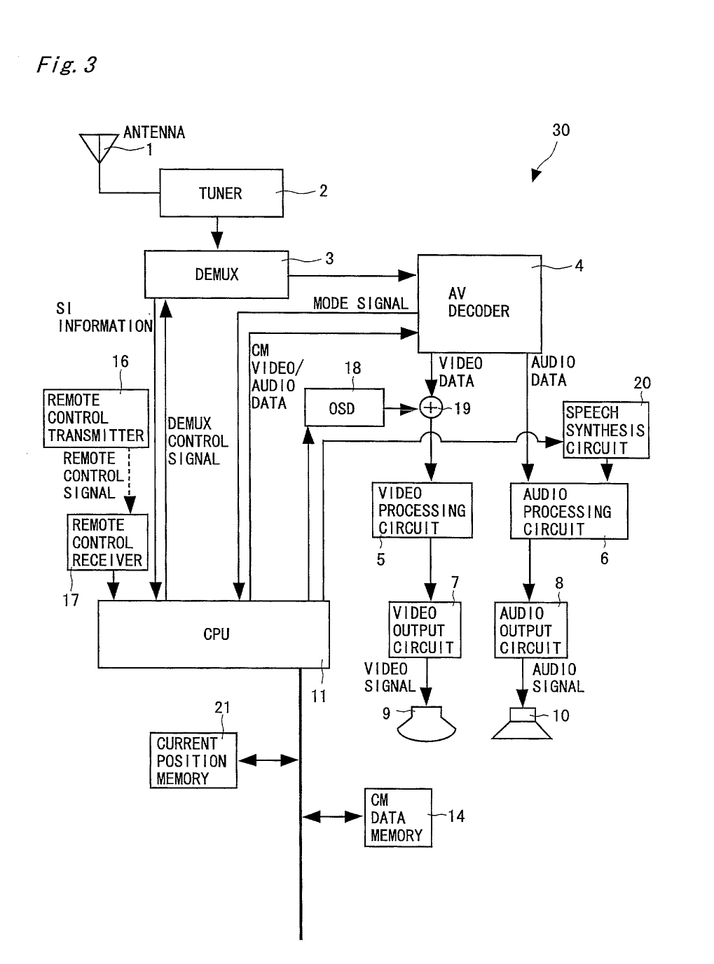

FIG. 3 is a block diagram showing still another example of the digital broadcasting receiving device with an advertising information outputting function. A configuration shown in FIG. 3 is a configuration comprising a current position memory 21 in place of the GPS receiving circuit 12 and the beacon receiving circuit 13 in the configuration shown in FIG. 2. FIG. 3 assumes a digital broadcasting receiving device with an advertising information outputting function which is placed in a home or the like.

The current position memory 21 may store, when a user performs auto channel setting on the basis of an area number, the area number as information related to the current position or store information related to the current position which is entered by the user using a remote control transmitter 16. The information related to the current position is not limited to information related to latitude and longitude. For example, it can be also character information representing the names of a city, a town and a village. Further, a postal code or a telephone number can be also utilized as the information related to the current position in addition to the information related to the names of a city, a town and a village.

When advertising area information carried on a digital broadcasting wave is the names of a city, a town, and a village, a postal code, or the like, the information related to the current position which is the names of a city, a town and a village, a postal code, or the like can be fed to the CPU 11 as it is. On the other hand, when the advertising area information carried on the digital broadcasting wave is latitude and longitude, it is possible to feed the information related to latitude and longitude to the CPU 11 by providing a correspondence table between the names of a city, a town and a village, the postal code, or the like and the latitude and longitude.

The CPU 11 automatically outputs, when advertising information corresponding to the current position exists, as in the configurations shown in FIGS. 1 and 2, the advertising information in place of a commercial appended to broadcasting, or outputs a message for informing the user that the advertising information exists, and then outputs the advertising information in an operation performed by the user.

Although description was made as an example of a case where ground wave digital broadcasting is viewed, the present invention is not limited to the same. It can be also applied to a case where BS digital broadcasting or the like is viewed.

As described in the foregoing, according to the digital broadcasting receiving device with an advertising information outputting function in the present invention, such an effect that in a place where a viewer is currently positioned, local commercials corresponding to the place can be presented to the viewer by the digital broadcasting wave or on the basis of the advertising information previously stored.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital broadcasting receiving device with an advertising information outputting function, comprising:
a receiver for receiving a digital broadcasting wave;
video/audio output means for outputting at least one of video and audio;
means for taking out advertising information and advertising area information which are carried on the digital broadcasting wave;
means for outputting information related to the current position;
selection means for selecting the advertising information by the contrast between the information related to the current position and the advertising area information; and
a controller for feeding the selected advertising information to said video/audio output means at predetermined timing.

2. A digital broadcasting receiving device with an advertising information outputting function, comprising:
a first receiver for receiving a digital broadcasting wave;
video/audio output means for outputting at least one of video and audio;
means for taking out advertising information and advertising area information which are carried on the digital broadcasting wave;
a second receiver for receiving a transmission wave on which information required to specify the current position is carried;
means for outputting information related to the current position on the basis of the information carried on said transmission wave;
selection means for selecting the advertising information by the contrast between the information related to the current position and the advertising area information; and
a controller for feeding the selected advertising information to said video/audio output means at predetermined timing.

3. In the digital broadcasting receiving device with an advertising information outputting function according to claim 1, a digital broadcasting receiving device with an advertising information outputting function, comprising
a memory storing the advertising information and the advertising area information which are taken out of the digital broadcasting wave,
said selection means being constructed such that the advertising information stored in said memory can be selected by the contrast between the information related to the current position and the advertising area information.

4. In the digital broadcasting receiving device with an advertising information outputting function according to claim 2, a digital broadcasting receiving device with an advertising information outputting function, comprising
a memory storing the advertising information and the advertising area information which are taken out of the digital broadcasting wave,
said selection means being constructed such that the advertising information stored in said memory can be selected by the contrast between the information related to the current position and the advertising area information.

5. A digital broadcasting receiving device with an advertising information outputting function, comprising:
a first receiver for receiving a digital broadcasting wave;
video/audio output means for outputting at least one of video and audio;
a memory storing advertising information and advertising area information;
a second receiver for receiving a transmission wave on which information required to specify the current position is carried;
means for outputting information related to the current position on the basis of the information carried on said transmission wave;
selection means for selecting the advertising information by the contrast between the information related to the current position and the advertising area information; and
a controller for feeding the selected advertising information to said video/audio output means at predetermined timing.

6. In the digital broadcasting receiving device with an advertising information outputting function according to claim 1, a digital broadcasting receiving device with an advertising information outputting function, comprising
judgment means for judging whether or not video and audio which are being currently outputted are a commercial (CM) appended to a program,
said controller being so constructed as to feed to said video/audio output means the advertising information selected when said judgment means judges that they are a commercial.

7. In the digital broadcasting receiving device with an advertising information outputting function according to claim 2, a digital broadcasting receiving device with an advertising information outputting function, comprising
judgment means for judging whether or not video and audio which are being currently outputted are a commercial (CM) appended to a program,
said controller being so constructed as to feed to said video/audio output means the advertising information selected when said judgment means judges that they are a commercial.

8. In the digital broadcasting receiving device with an advertising information outputting function according to claim 3, a digital broadcasting receiving device with an advertising information outputting function, comprising
judgment means for judging whether or not video and audio which are being currently outputted are a commercial (CM) appended to a program,
said controller being so constructed as to feed to said video/audio output means the advertising information selected when said judgment means judges that they are a commercial.

9. In the digital broadcasting receiving device with an advertising information outputting function according to claim 4, a digital broadcasting receiving device with an advertising information outputting function, comprising
judgment means for judging whether or not video and audio which are being currently outputted are a commercial (CM) appended to a program,
said controller being so constructed as to feed to said video/audio output means the advertising information selected when said judgment means judges that they are a commercial.

10. In the digital broadcasting receiving device with an advertising information outputting function according to claim 5, a digital broadcasting receiving device with an advertising information outputting function, comprising
judgment means for judging whether or not video and audio which are being currently outputted are a commercial (CM) appended to a program,
said controller being so constructed as to feed to said video/audio output means the advertising information selected when said judgment means judges that they are a commercial.

11. In the digital broadcasting receiving device with an advertising information outputting function according to claim 1, a digital broadcasting receiving device with an advertising information outputting function, wherein
said controller is so constructed as to feed the advertising information selected in said selection means to said video/audio output means simultaneously with the selection.

12. In the digital broadcasting receiving device with an advertising information outputting function according to claim 2, a digital broadcasting receiving device with an advertising information outputting function, wherein
said controller is so constructed as to feed the advertising information selected in said selection means to said video/audio output means simultaneously with the selection.

13. In the digital broadcasting receiving device with an advertising information outputting function according to claim 3, a digital broadcasting receiving device with an advertising information outputting function, wherein
said controller is so constructed as to feed the advertising information selected in said selection means to said video/audio output means simultaneously with the selection.

14. In the digital broadcasting receiving device with an advertising information outputting function according to claim 4, a digital broadcasting receiving device with an advertising information outputting function, wherein
said controller is so constructed as to feed the advertising information selected in said selection means to said video/audio output means simultaneously with the selection.

15. In the digital broadcasting receiving device with an advertising information outputting function according to claim 5, a digital broadcasting receiving device with an advertising information outputting function, wherein
said controller is so constructed as to feed the advertising information selected in said selection means to said video/audio output means simultaneously with the selection.

16. In the digital broadcasting receiving device with an advertising information outputting function according to claim 1, a digital broadcasting receiving device with an advertising information outputting function, wherein
said controller is so constructed as to feed the advertising information selected in said selection means to said video/audio output means when a signal representing the timing of outputting the advertising information is received.

17. In the digital broadcasting receiving device with an advertising information outputting function according to claim 2, a digital broadcasting receiving device with an advertising information outputting function, wherein
said controller is so constructed as to feed the advertising information selected in said selection means to said video/audio output means when a signal representing the timing of outputting the advertising information is received.

18. In the digital broadcasting receiving device with an advertising information outputting function according to claim 3, a digital broadcasting receiving device with an advertising information outputting function, wherein
said controller is so constructed as to feed the advertising information selected in said selection means to said video/audio output means when a signal representing the timing of outputting the advertising information is received.

19. In the digital broadcasting receiving device with an advertising information outputting function according to claim 4, a digital broadcasting receiving device with an advertising information outputting function, wherein
said controller is so constructed as to feed the advertising information selected in said selection means to said video/audio output means when a signal representing the timing of outputting the advertising information is received.

20. In the digital broadcasting receiving device with an advertising information outputting function according to claim 5, a digital broadcasting receiving device with an advertising information outputting function, wherein
said controller is so constructed as to feed the advertising information selected in said selection means to said video/audio output means when a signal representing the timing of outputting the advertising information is received.

21. In the digital broadcasting receiving device with an advertising information outputting function according to claim 1, a digital broadcasting receiving device with an advertising information outputting function, comprising
message output means for outputting a message saying that the advertising information exists,
said controller is so constructed as to feed the advertising information selected when an advertising output operation is performed by a user to said video/audio output means.

22. In the digital broadcasting receiving device with an advertising information outputting function according to claim 2, a digital broadcasting receiving device with an advertising information outputting function, comprising
message output means for outputting a message saying that the advertising information exists,
said controller is so constructed as to feed the advertising information selected when an advertising output operation is performed by a user to said video/audio output means.

23. In the digital broadcasting receiving device with an advertising information outputting function according to claim 3, a digital broadcasting receiving device with an advertising information outputting function, comprising
message output means for outputting a message saying that the advertising information exists,
said controller is so constructed as to feed the advertising information selected when an advertising output operation is performed by a user to said video/audio output means.

24. In the digital broadcasting receiving device with an advertising information outputting function according to claim 4, a digital broadcasting receiving device with an advertising information outputting function, comprising
message output means for outputting a message saying that the advertising information exists,
said controller is so constructed as to feed the advertising information selected when an advertising output operation is performed by a user to said video/audio output means.

25. In the digital broadcasting receiving device with an advertising information outputting function according to claim 5, a digital broadcasting receiving device with an advertising information outputting function, comprising
message output means for outputting a message saying that the advertising information exists,
said controller is so constructed as to feed the advertising information selected when an advertising output operation is performed by a user to said video/audio output means.
